(19) United States
(12) Patent Application Publication
(10) Pub. No.: US 2009/0243530 A1
(43) Pub. Date: Oct. 1, 2009

(54) Variable voltage output power source for model trains

(76) Inventors: Zhiping Lin, Kearny, NJ (US); Frank Ritota, Brick, NJ (US)

Correspondence Address: JONATHANE E. GRANT, 2107 HOUNDS RUN PLACE, SILVER SPRING, MD, 20906, US

(21) Appl. No.: 12/078,304

(22) Filed: Mar. 28, 2008

(51) Int. Cl. H02P 27/02

(52) U.S. Cl. 318/504

(57) ABSTRACT

An apparatus that provides electrical power for the operation of analog motors or decoder-equipped motors, said apparatus comprising:
e) a power source having variable voltage output for operating analog motors and/or fixed voltage output for operating decoder-equipped motors;
f) a circuit for changing the output of the power source from variable voltage output to fixed voltage output and from a fixed voltage output to a variable voltage output;
g) a means to vary the analog voltage output; and
h) a switch to actuate the circuit and thus the change from a variable voltage output to a fixed voltage output and from fixed voltage output to variable voltage output.

### FIELD OF THE DISCLOSURE

This disclosure pertains to the field of control systems for model and toy trains, and specifically a power system used to provide the operating power via the train track.

### BACKGROUND OF THE DISCLOSURE

Model and toy trains have undergone numerous evolutions from the earliest forms of the electrically-powered trains, using a two track system for DC powered trains, and a three track system for AC powered trains in order to provide a source of power to the motors contained within the body of the model and toy trains. Generally, these elements were in the form of simulated track wherein the DC powered trains included two rails upon which the wheels of the train would ride, with the wheels acting as a conduit for the electricity used to power the motor located in the train. In the case of AC powered trains, a third rail was included in the center portion of the simulated train track, with one side (polarity) of the power provided to the center rail, and the other side (polarity) of the power provided on both outside rails of the train track. Wheels on the AC powered trains would pick up the outside rails that, along with the center rail pickup “shoe”, would provide the AC power for the motor located within the body of the model or toy train.

The power source for these trains includes a step-down transformer that steps down the household voltage to the necessary voltage used by the motors located inside the trains. Additionally, a means for adjusting the voltage to the motors is used to provide variable speeds to the trains, with adjustment provided by a control knob located on the power source or a separate controller that provides instructions to the power source This separate controller, sometimes located on a remote control device, can also be used to activate various other functions, and can also contain a display for indicating operation, speed, etc. of the train under control.

In the past, trains were often relegated to “toy” status, having cast bodies that simulated real trains, and crude lighting and smoke effects. Additionally, there was also provided some form of sound, usually a horn and/or a bell that included small, electrically driven devices in the bodies of the trains or associated cars. These types of model trains are generally referred to as analog trains insofar as the motors within these trains are directly powered by the train track voltages as a means to govern their speed and direction, and would include some means using the analog track voltage to operate the smoke and limited sound effects. Developments in the early 60's with HO-gauge trains directed an increasingly larger portion of the toy train enthusiasts to more highly detailed and train and cars. The 80's saw the development of digital control schemes for model trains, with highly detailed castings and add-on features, and with multiple sound, smoke, and light features that became increasingly the domain of the digital circuitry. These trains included what are known as digital decoders, or simply decoders, to denote the inclusion of an electronic circuit within the body of the train. Thus, a number of digital control schemes for the generation of control signals for the digital circuitry contained within the train bodies were developed. These schemes, such as the Lenz Digital Command Control, or DCC, Marklin's Digital Systems (for AC powered trains), Lionel's Trainmaster Control, and MTH's digital control system, among others, provide for huge improvements in the areas of prototypical sound, light, and smoke operations, and also provide for multi-train operation on the same electrically powered track. Generally, these systems have the track voltage, whether DC or AC, at full power, and incorporate digital signals into the track voltage. These signals instruct the digital-equipped train decoders to operate in the fashion desired by the model train operator through the decoders contained within the model train bodies, the power sources for these digital systems having an array of buttons to operate the various features on the thus equipped trains.

These digital systems, because of the necessity of providing full track voltage to operate the digital-equipped trains, will not allow operation of the older, analog trains that use a variable track voltage to operate the train motor, on the same track. Therefore, an operator that has both decoder-equipped trains and conventional, analog trains must change power sources when they run either digital or analog trains on the same track setup. This means that the power source, (for example, an analog system), must be electrically removed from the train tracks and replaced with a digital power source when it is desired to run decoder-equipped trains. Conversely, the power source for a decoder-equipped train must be removed from the train tracks and replaced with an analog power source when it is desired to run an analog train.

U.S. Pat. No. 6,536,716 (Ireland et al) introduces the concept of conversion of surplus or superseded older power packs or direct current control devices to become conversion throttles that then have the associated features of add-on digital throttles wherein the features of these add-on throttles are “exported” to the conversion throttles for operation of decoder-equipped trains.

U.S. Pat. No. 4,572,996 (Hanschke et al) introduces the concept of a control unit that allows the use of decoder-equipped model trains to be operated on an analog voltage track.

U.S. Pat. No. 7,142,954 (Neiser) discloses a model train controller interface device provides a user with the capability of operating model train engine, switch and accessories of one manufacturer with the handheld wireless device of a second manufacturer. Inserted between the command base units and controller devices of different model train manufacturers, the interface device allows the wireless remote of one train system to operate components of the other train system without loss of functionality by either model train system.

U.S. Pat. Nos. 6,281,606 and 6,624,537 (Westlake) discloses A plural output control station for operating electrical apparatus, such as model electric train engines and accessories. The control station employs a data processor for monitoring and controlling the signals generated at a plurality of transformer-driven power output terminals. An exemplary station includes two variable-voltage alternating current (AC) output channels (TRACK 1 and TRACK 2) and two fixed-voltage AC output channels (AUX 1 & AUX 2). The variable-voltage outputs are controlled by a data processor responsive to respective operator-controlled throttles for varying the AC output voltage and therefore the rate of movement and direction of electric train engines, typically three-rail O-gauge model trains.

None of the above listed patents disclose the simple application of a user operated control device to switch the output of a model train power source from a variable power source for use with analog trains, to a digital source for use with decoder-equipped trains, and vise versa. Additionally, the above patents do not disclose a circuit that can determine whether a train has a decoder and automatically switch the power source to digital operation mode.

### SUMMARY OF THE DISCLOSURE

The present power source solves the problems discussed supra. More specifically, a single power source and method of use are taught that is capable of operating either analog or decoder equipped trains on a model train track layout without the need for swapping power sources.

In one embodiment of the disclosure, a single user operation is provided to change from either a variable voltage output for use with analog trains or a full voltage output with digital signals for use with decoder equipped trains.

In another embodiment of the disclosure, a second circuit within the power source which includes the ability for detecting the presence of decoder modules in trains that are connected to the power source and automatically switch from variable voltage output to full voltage output with digital signals.

In one embodiment of the disclosure, the apparatus which provides electrical power for the operation of analog motors or decoder-equipped motors, said apparatus comprises a power source having variable voltage output for operating analog motors and/or fixed voltage output for operating decoder-equipped motors, a circuit for changing the output of the power source from variable voltage output to fixed voltage output and from a fixed voltage output to a variable voltage output, an electronic element to vary the analog voltage output; and a switch to actuate the circuit and thus the change from a variable voltage output to a fixed voltage output and from fixed voltage output to variable voltage output.

In another embodiment of the disclosure, the power source provides AC or DC power at full voltage and includes the capability to provide digital signals to operate decoder-equipped motors.

In another embodiment of the disclosure, the circuit is contained within the case of the power source.

In yet another embodiment, the circuit is electrically connected to a user operable electric switch to change the output of the power source from a variable voltage output to a fixed voltage output and from a fixed voltage output to a variable voltage output.

In yet another embodiment, the element for varying the analog voltage output includes a handle connected to a variable electronic element that is connected to the power source

In yet another embodiment, the switch comes from the list of pushbutton switches, toggle switches, and slide switches.

In yet another embodiment, the analog motors and decoder-equipped motors are located in models and toys.

In yet another embodiment, motor-equipped models and toys are in direct electrical connection with the power source.

In one embodiment, a second circuit is taugth for sensing the presence of decoder equipped motors and automatically placing the power source into fixed voltage output.

In yet another embodiment, the decoder equipped motors are located in toys and models and are in electrical connection with the power source.

The disclosure will accordingly comprise the features of construction and the combination and arrangement of elements which will be exemplified in the following detailed description.

### BRIEF DESCRIPTION OF THE DRAWINGS

FIG. 1 is a perspective view of a prior art power source;

FIG. 2 is a perspective view of a prior art power supply with remote control;

FIG. 3 is a schematic view of a prior art power source;

FIG. 4 is a schematic view of the multifunctional power source with the inclusion of the user operated switch and controller circuit;

FIG. 5. is a schematic view of the components and of the user operated switch and controller circuit;

FIG. 6. is a schematic view of the multi functional power source with the inclusion of the controller circuit connection to operate the mode changing circuit;

FIG. 6 is a schematic view of the controller circuit with the inclusion of the remote control receiver circuit;

FIG. 8. is a schematic view of the controller circuit with the inclusion of the decoder sensing circuit; and

FIG. 9 is a perspective view of the multifunctional power source connected to a train track layout.

### DETAILED DESCRIPTION OF THE DISCLOSURE

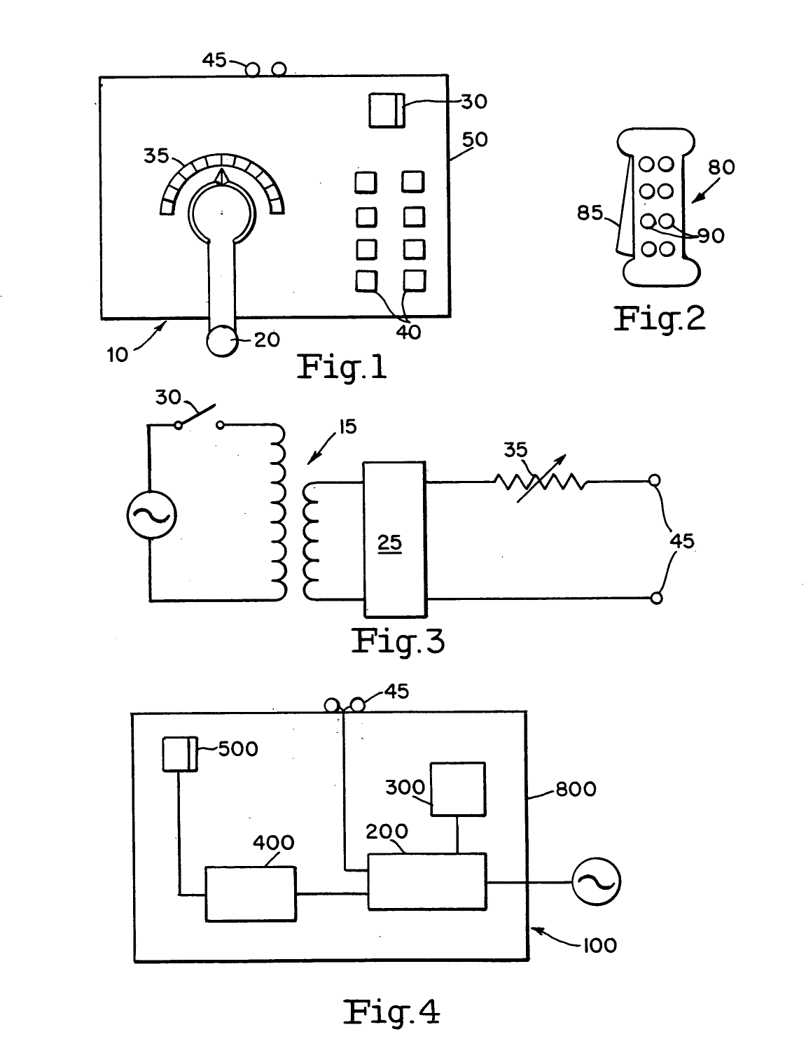

FIGS. 1 thru 3 show the prior art relating to power sources for model trains. A typical analog power source 10 (contained in case 50), is shown, wherein the voltage, either AC or DC, is cause to vary via a rheostat 35 having a handle 20, a power switch 30 is used to turn on and off power supplied to the power source from the household current. A plurality of switches 40, in the form of buttons, are used to perform functions located in the model train, such as whistle, bell, smoke and the like. Additionally, switches 40 may be used to actuate trackside accessories, such as track switches, uncouplers, lights, and the like. The power to the track, whether AC or DC, is varied in voltage level via the rheostat so as to cause the train to move at the desired speed. A model train track layout is connected to output terminals 45. Where a remote control device is used, a remote control device 80 having plurality of switches 90 is used to perform the whistle, bell, smoke, etc. Additionally, the buttons 90 on the remote control may be used to actuate trackside accessories. A handle or dead man's switch 85 is provided for the operator to adjust the speed of the model train.

FIG. 3 is a schematic representation of the power source, showing a step down transformer 15, power switch 30, a power conditioning circuit 25, and rheostat 35. The power conditioning circuit is used to generate the power from the step down transformer to the type of power needed to operate the model trains. This power may be either AC or DC, bi polar or pulse-width modulated (PWM) or in whatever form needed to operate the model trains, and is varied via rheostat 35 to output terminals 45.

While it is noted in the prior art to have a power source with both a variable voltage out put and a fixed voltage output, the fixed voltage output is always used for the operation of accessories, and not for the operation of decoder equipped trains.

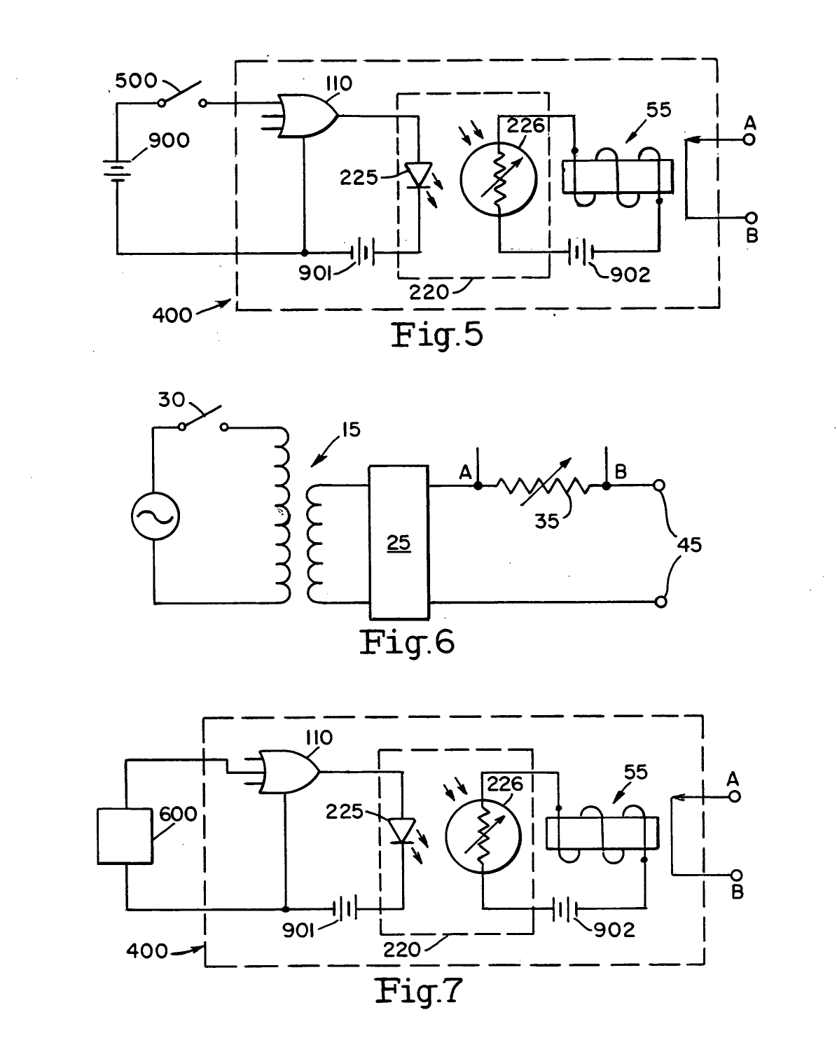

Referring to FIGS. 4-7, the present disclosure contains a multifunctional power source 100 including a power supply 200 in a case 800. Digital decoder signal circuit 300 is used to generate digital signals that control decoder equipped trains, with the digital signals “injected” into the fixed voltage output circuit. Controller circuit 400 is used to control a relay 550 that is electrically connected across the rheostat 35 such that when the relay is closed, the power output goes from being variable to being fixed at the full voltage output by virtue of rheostat 35 being shorted. Controller circuit 400 includes a source of power 900 thru 902, an OR gate 110 and an optoisolator 220, the optoisolator comprising a light source 225 (in this case, an LED) and a photoresistor 226 in a single package. The operation of controller circuit 400 is performed by manually moving switch 500. This switch, normally a lever or button, is connected to controller circuit 400, such that when the switch is closed, current from power supply 900 flows through the switch to one of the input terminals on OR gate and sets the gate high. This in turn causes current from power supply 901 to flow through the OR gate into the LED 225 causing it to light up and lower the resistance of photoresistor 226 that is in circuit with relay. With the resistance of the photoresistor lowered by the light shining on it, the photoresistor allows the current from power supply 902 to flow into the relay, pulling the contacts of the relay down and shorting out the rheostat. This, in effect, changes the voltage output from a variable voltage output to a fixed voltage output. Conversely, when switch 500 is open, no voltage flows through the switch, the OR gate is set low and no voltage flows into the LED from power supply 901, the resistance of the photoresistor is then high, preventing powering from power supply 902 flowing into relay 55. Because not current flows into relay 55, the relay contacts are not pulled down and rheostat 35 is not shorted out. While controller circuit 400 is shown as a separate module, it can be incorporated onto the board containing the power supply 200. It should also be noted that power supplies 900 thru 902 would normally be derived from a single power source as a portion of the main power supply 200.

Thus, the same train layout can be used to operate either digital, decoder-equipped model trains, or older, analog trains without having to physically remove and replace the track power source. Also, the model train operator has need for only one power source for operation of both types of model trains, with the obvious savings in money and space provided by the disclosed equipped power source.

An additional aspect of the disclosure includes the provision of a remote control receiver circuit 600 that receives a signal from a wired or wireless controller 80, the output from circuit 600 connected to one of the input terminals of OR gate 110. When the output from circuit 600 is a positive voltage (high), the OR gate is set high, allowing voltage to flow from power supply 901 into optoisolator 220, which, in turn, latches relay 55 down, shorting out rheostat 35. This operation is similar in operation to the use of switch 500, whereas a positive voltage from circuit 600 sets one of the input gates of the OR gate high, allowing power to flow into the optoisolator 220 and activate the relay to short out rheostat 55. When no voltage flows from circuit 600, the OR gate is set low and no voltage flows into the optoisolator, and thus the relay is not latched and the rheostat is not shorted out.

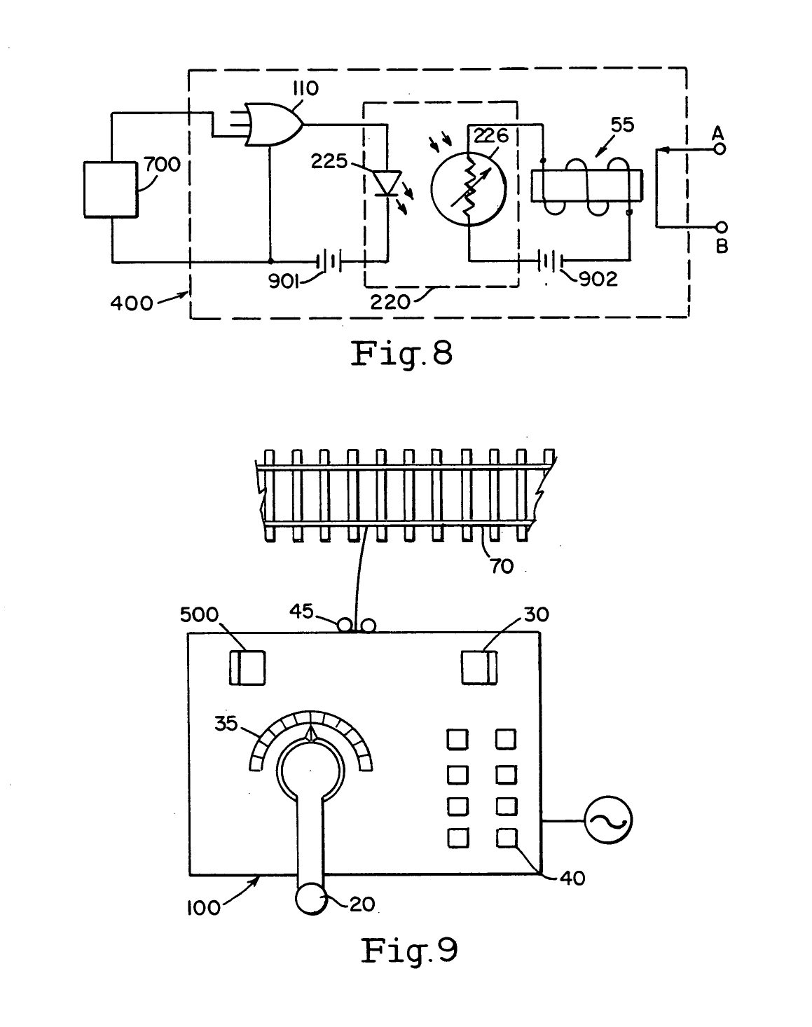

An additional aspect of the disclosure shown in FIG. 8 includes a decoder sensing circuit 700 contained within the case 800 of the multifunctional power source 100 that determines the presence of a decoder-equipped train on the model train track and automatically put the power source into fixed voltage output mode. As shown in FIG. 9, Such a circuit 700, connected to train track 70 via the output terminals 45 transmits a signal to the train track 70 to determine the presence of a decoder-equipped model train. If the signal is returned, a decoder equipped train is present, and circuit 700 drives another of the input gates of OR gate 100 high with a positive voltage, thus allowing current from power supply 901 to flow into optoisolator 220 which allows the current from power supply 902 to flow into the relay, pulling the contacts of the relay down and shorting out the rheostat. If the signal is not returned, circuit 700 provides no voltage to the input terminal of the OR gate, the OR gate is then set low and no voltage flows into the optoisolator, and thus the relay is not latched and the rheostat is not shorted out.

It should be noted that disclosure provides for operation of a model train layout in either digital or analog mode with a single power source, there cannot be a mix of analog and decoder-equipped trains on the same model train layout. Additionally, the power source of the disclosure can also be used to operate model train layouts that include a mix of model trains and various accessories, including those accessories that include digitally-operated decoders, such as turnout switches, lights, motor operated cranes, and the like.

While the presently preferred embodiments have been described above, various other modifications and adaptations of the instant disclosure can be made by those persons skilled in the art without departing from either the spirit of the invention or the scope of the appended claims.

What we claim is:

1. An apparatus that provides electrical power for the operation of analog motors or decoder-equipped motors, said apparatus comprising:
a) a power source having variable voltage output for operating analog motors and/or fixed voltage output for operating decoder-equipped motors;
b) a circuit for changing the output of the power source from variable voltage output to fixed voltage output and from a fixed voltage output to a variable voltage output;
c) a means to vary the analog voltage output; and
d) a switch to actuate the circuit and thus the change from a variable voltage output to a fixed voltage output and from fixed voltage output to variable voltage output.

2. The apparatus in accordance with claim 1, wherein said power source provides AC or DC power at full voltage and includes the capability to provide digital signals to operate decoder-equipped motors.

3. The apparatus in accordance with claim 1, wherein said circuit is contained within the case of the power source.

4. The apparatus in accordance with claim 1, wherein said circuit is electrically connected to a user operable electric switch to change the output of the power source from a variable voltage output to a fixed voltage output and from a fixed voltage output to a variable voltage output.

5. The apparatus in accordance with claim 1, wherein the means for varying the analog voltage output includes a handle connected to a variable electronic element that is connected to the power source

6. The apparatus in accordance with claim 4, wherein said switch comes from the list of pushbutton switches, toggle switches, and slide switches.

7. The apparatus in accordance with claim 1, wherein said analog motors and decoder-equipped motors are located in models and toys.

8. The apparatus in accordance with claim 1, wherein said motor-equipped models and toys are in direct electrical connection with said power source.

9. An apparatus that provides electrical power in either AC or DC form for the operation of either analog motors or decoder-equipped motors, said apparatus comprising:
a. a power source contained within a case, said power source having variable voltage output for operating analog motors or fixed voltage output for operating decoder-equipped motors;
b. a circuit for changing the state of the power source from variable voltage output to fixed voltage output and from a fixed voltage output to a variable voltage output;
c. a means for varying the analog voltage output;
d. a switch to actuate the circuit and thus the change from a variable voltage output to a fixed voltage output and from fixed voltage output to variable voltage output; and
e. a second circuit for sensing the presence of decoder-equipped motors and automatically placing the power source into fixed voltage output.

10. The apparatus in accordance with claim 9, wherein said decoder equipped motors are located in toys and models.

11. The apparatus in accordance with claim 10, wherein said toys and models are in direct electrical connection to said power source.

12. A method for providing electrical power for the operation of analog or decoder-equipped motors, said method comprising:
a) connecting a power source to said motors, said power source having variable voltage output for operating analog motors and/or fixed voltage output for operating decoder-equipped motors;
b) activating a circuit for changing the output of the power source from a variable voltage output to fixed voltage output and from a fixed voltage out put to a variable voltage output;
c) operating a handle for varying the analog voltage output; and
d) operating a switch to activate the circuit and thus change from a variable voltage output to a fixed voltage output and from a fixed voltage output to a variable voltage output.

13. The method in accordance with claim 12, whereby operating the handle varies an adjustable electronic element.

14. The method in accordance with claim 12, whereby moving said switch from one position to the opposite position changes the operation of said circuit.

15. A method for providing electrical power for the operation of analog or decoder-equipped motors, said method comprising:
a) connecting a power source to said motors, said power source having variable voltage output for operating analog motors and/or fixed voltage output for operating decoder-equipped motors;
b) sensing the presence of decoder-equipped motors and placing said power source into full voltage output; and
c) operating a handle for varying the analog voltage output.

16. The method in accordance with claim 15, whereby the change from a variable voltage output to a fixed voltage output provides digital signals to the decoder-equipped motors.
